(19) United States
(12) Patent Application Publication
(10) Pub. No.: US 2012/0163294 A1
(43) Pub. Date: Jun. 28, 2012

(54) PACKET DATA TRANSFER APPARATUS AND PACKET DATA TRANSFER METHOD IN MOBILE COMMUNICATION SYSTEM

(75) Inventors: Duck Hwan KIM, Daejeon (KR); Bon Tae KOO, Daejeon (KR)

(73) Assignee: Electronics and Telecommunications Research Institute, Daejeon (KR)

(21) Appl. No.: 13/305,439

(22) Filed: Nov. 28, 2011

(30) Foreign Application Priority Data
Dec. 22, 2010 (KR) 10-2010-0132910

(51) Int. Cl. H04W 4/00

(52) U.S. Cl. 370/328

(57) ABSTRACT

Disclosed are a packet data transfer apparatus and a packet data transfer method in a mobile communication system. In the mobile communication system, the packet data transfer apparatus reduces a load of a protocol stack processor, which causes performance degradation due to a considerable time taken to transfer a large amount of packet data to a memory of a packet processor from Ethernet, so that the clock speed of the processor can be lowered. Accordingly, it is possible to implement a modem for mobile communication using low power. Further, the packet data transfer apparatus is positioned between a processor and a memory so that the processor does not perform packet data transfer from the outside to an internal memory of the process or packet data transfer from the internal memory of the process to the outside. Accordingly, it is possible to reduce packet data transfer of the processor.

### CROSS-REFERENCES TO RELATED APPLICATIONS

The present application claims priority under 35 U.S.C 119(a) to Korean Application No. 10-2010-0132910, filed on Dec. 22, 2010, in the Korean Intellectual Property Office, which is incorporated herein by reference in its entirety set forth in full.

### BACKGROUND

Exemplary embodiments of the present invention relate to a packet data transfer apparatus and a packet data transfer method in a mobile communication system, and more particularly, to a packet data transfer apparatus and a packet data transfer method in a mobile communication system, which can reduce the load of a protocol stack processor in the mobile communication system.

In general, a protocol stack processor is used to process packets transferred in a mobile communication system or mobile communication terminal (hereinafter, referred to as a ‘mobile communication system’).

A protocol stack is referred to as a protocol suite, and means a set of communication protocols organized into a hierarchical structure. The protocol stack has the same structure as that in which a communication process is divided into several layers and the layers are stacked one by one so as to perform reliable communication.

The protocol stack processor is a processor capable of processing packet data suitable for the protocol stack. As packet data to be processed increases, the protocol stack process requires excellent processing performance.

In addition to analysis of packet data to be processed, the protocol stack processor moves data to a data memory in the protocol stack processor from the outside or transfers data to the outside from the data memory in the protocol stack process so as to process packet data. In this process, the performance of the protocol stack processor is degraded.

Therefore, a modem for mobile communication with a high clock speed or a high-speed mobile communication system that supports fast data transfer rates is required so as to prevent performance degradation. In this case, the processor with the high clock speed uses high-priced components and generates a large amount of heat as the clock speed increases.

For this reason, a new method for implementing a modem for mobile communication using low power is required to increase the operating time of the modem used in a mobile communication system and decrease the price of components.

### SUMMARY

An embodiment of the present invention relates to a packet data transfer apparatus and a packet data transfer method in a mobile communication system, in which the load of a protocol stack processor, which causes performance degradation, is reduced, so that the clock speed of the protocol stack processor can be lowered, thereby implementing a modem for mobile communication using low power.

Another embodiment of the present invention relates to a packet data transfer apparatus and a packet data transfer method in a mobile communication system, in which the packet data transfer apparatus is positioned between a processor and a memory so that the processor does not perform packet data transfer from the outside to an internal memory of the process or packet data transfer from the internal memory of the process to the outside, thereby reducing packet data transfer of the processor.

In one embodiment, a packet data transfer method in a mobile communication system, the method includes transferring, by a microcontroller, packet data to a memory; informing, by the microcontroller, a packet data transfer apparatus of transfer completion of the packet data; informing, by the packet data transfer apparatus, a protocol stack processor that the packet data has been transferred to the memory; reading, by the protocol stack processor, a header of the packet data from the memory, storing the header to be added to a protocol stack and then informing the packet data transfer apparatus of position information on the header; calculating, by the packet data transfer apparatus, a position of the header added to the memory; and reading, by the packet data transfer apparatus, the packet data and the header based on the calculated position and transferring the packet data and the header to a modem.

The informing of the packet data transfer apparatus of the transfer completion of the packet data may be performed through an MCU interface unit of the packet data transfer apparatus for interface with the microcontroller.

The informing step of the protocol stack processor that the packet data has been transferred to the memory, and the reading of the header of the packet data from the memory, the storing of the header to be added to the protocol stack and the informing of the packet data transfer apparatus of position information on the header step may be performed through a PSP interface unit of the packet data transfer apparatus for interface with the protocol stack processor.

In another embodiment, a packet data transfer method in a mobile communication system includes receiving, by a modem, packet data from another mobile communication system and then informing a packet data transfer apparatus of existence of the received packet data; calculating, by the packet data transfer apparatus, a position at which the packet data received from the modem is to be stored in a memory; transferring the packet data of the modem to the calculated position of the memory and then informing the protocol stack processor that newly received packet data has been positioned in the memory; reading, by the protocol stack processor, a header of the packet data from the memory, removing the header from the packet data and then recording position information of payload data at a point previously specified in the memory; informing, by the protocol stack processor, a microcontroller of existence of the payload data to receive; and reading, the microcontroller, the payload data based on the position information recorded at the point previously specified in the memory.

The receiving of the packet data from another mobile communication system and then the informing of the packet data transfer apparatus of existence of the received packet data may be performed through a modem interface unit of the packet data transfer apparatus for interface with the modem.

The transferring of the packet data of the modem to the calculated position of the memory and the informing of the protocol stack processor that the newly received packet data has been positioned in the memory may be performed through a PSP interface unit of the packet data transfer apparatus for interface with the protocol stack processor.

The reading of the header of the packet data from the memory, the removing of the header from the packet data and the recording of the position information of payload data at the point previously specified in the memory may be performed through the PSP interface unit of the packet data transfer apparatus for interface with the protocol stack processor and an MCU interface unit of the packet data transfer apparatus for interface with the microcontroller.

In another embodiment, a packet data transfer apparatus in a mobile communication system includes: a PSP interface unit configured to communicate a first control signal with a protocol stack processor for analyzing a protocol of received packet data; an MCU interface unit configured to communicate a second control signal with a microcontroller for communicating the packet data through Ethernet; a modem interface unit configured to communicate a third control signal with a modem for communicating the packet data with another mobile communication system; a data pointer calculation unit configured to calculate a data pointer of a memory under the control of the microcontroller and the protocol stack processor; and a data transfer unit configured to transfer both first packet data stored in the memory by the microcontroller and the header added by the protocol stack processor to the modem, or to transfer second packet data received by the modem from the another mobile communication system to the memory, based on the data pointer calculated by the data pointer calculation unit.

The first control signal is one of a transfer completion message informing of transfer completion of the first packet data from the microcontroller to the memory, a reception completion message informing of reception completion of the second packet data from the modem to the memory, position information of the header to be added by the protocol stack processor and a payload message informing of existence of payload data in the memory, the second control signal is one of the transfer completion message and the payload message, and the third control signal is a message informing of existence of the second packet data.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram schematically illustrating an interface between a packet data transfer apparatus and peripheral devices in a mobile communication system according to an embodiment of the present invention;

FIG. 2 is a block diagram schematically illustrating an overview of the configuration for the packet data transfer apparatus according to the embodiment of the present invention;

FIG. 3 is a block configuration diagram illustrating flows of data and signals for downlink data transfer in the mobile communication system according to an embodiment of the present invention;

FIG. 4 is a flowchart illustrating a downlink packet data transfer method according to the embodiment of the present invention;

FIG. 5 is a block diagram illustrating the configuration for the data and signal flow to uplink data transfer in the mobile communication system according to another embodiment of the present invention; and

FIG. 6 is a flowchart illustrating an uplink packet data transfer method according to the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

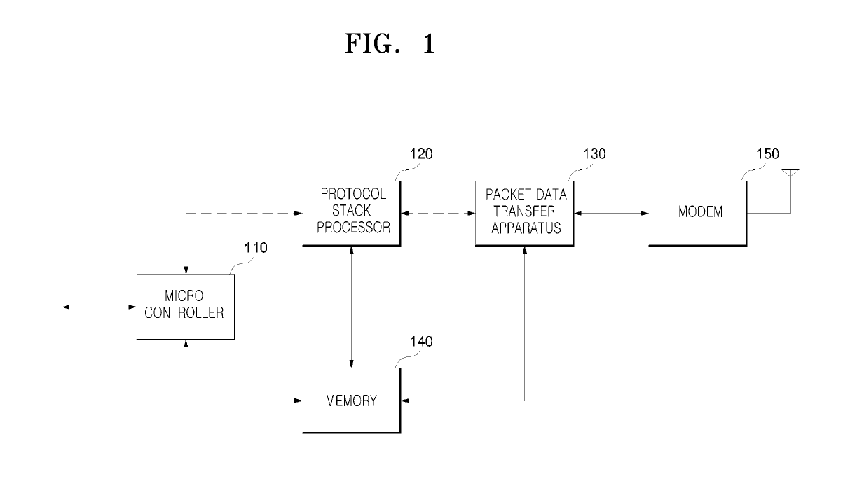

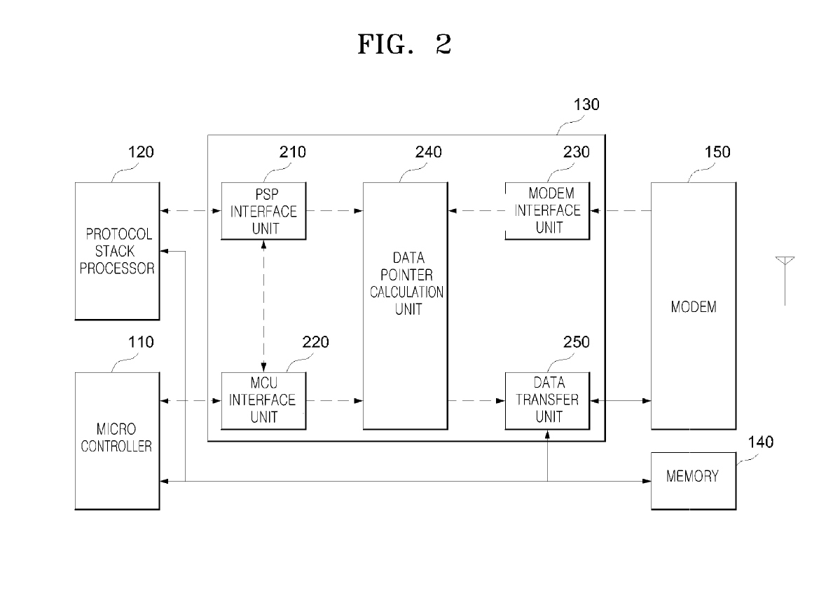

FIG. 1 is a block configuration diagram schematically illustrating an interface between a packet data transfer apparatus and peripheral devices in a mobile communication system according to an embodiment of the present invention. FIG. 2 is a block configuration diagram schematically illustrating the packet data transfer apparatus according to the embodiment of the present invention.

The mobile communication system according to this embodiment may use downlink packet data transfer and/or uplink packet data transfer. The downlink packet data transfer means that a mobile communication system transfers packet data to another mobile communication system through an antenna. The uplink packet data transfer means that a mobile communication system receives packet data transferred from another communication system through an antenna.

As illustrated in FIG. 1, the mobile communication system according to this embodiment includes a microcontroller 110, a protocol stack processor 120, a packet data transfer apparatus 130, a memory 140 and a modem 150.

The microcontroller 110 is connected to external Ethernet so as to provide, to an external device, transfer of packet data to the mobile communication system according to this embodiment through an uplink packet data transfer process or to transfer packet data received from the external device to another mobile communication system through a downlink packet data transfer process.

If a process of storing packet data received from the Ethernet in the memory 140 is completed in the downlink packet data transfer process, the microcontroller 110 transfers a transfer completion message to the packet data transfer apparatus 130.

If a message informing of existence of packet data to be received from the protocol stack processor 120 is received in the uplink packet data transfer process, the microcontroller 110 reads payload data based on position information recorded at a point previously specified in the memory 140.

The protocol stack processor 120 is a processor that performs a protocol stack so as to analyze the protocol of the received packet data. The protocol stack processor 120 can process packets suitable for a protocol stack having the same structure as that in which a communication process is divided into several layers and the layers are stacked one by one so as to perform reliable communication.

The protocol stack processor 120 does not necessarily stores packet data in an internal data memory (not shown). The protocol stack processor 120 may add a header to the packet data (in the downlink packet data transfer process) or remove the header from the packet data (in the uplink packet data transfer process) by analyzing the packet data stored in the memory 140 that is a separate component from the protocol stack processor 120.

In a case where the header is added to the packet data, the protocol stack processor 120 may inform the pack data transfer apparatus 130 of position information of the header to be added. In a case where the header is removed from the packet data, the protocol stack processor 120 may record position information of payload data at a point previously specified in the memory and inform the microcontroller 110 of the recorded position information.

The packet data transfer apparatus 130 is positioned between the protocol stack processor 120 and the memory 140. The packet data transfer apparatus 130 reduces a load of the protocol stack processor 120 by performing packet data transfer performed by the conventional protocol stack processor. Accordingly, it is possible to effectively use performance of the protocol stack processor 120 and implement a modem for mobile communication using low power.

The packet data transfer apparatus 130 can transfer packet data using a low media access control (LMAC) method.

As illustrated in FIG. 2, the packet data transfer apparatus 130 includes a PSP interface unit 210, an MCU interface unit 220, a modem interface unit 230, a data pointer calculation unit 240 and a data transfer unit 250.

The PSP interface unit 210 provides a first control signal between the packet data transfer apparatus 130 and the protocol stack processor 120. The first control signal provided to the protocol stack processor 120 is a message informing of transfer completion of downlink packet data from the microcontroller 110 to the memory 140 or a message informing of reception completion of uplink packet data from the modem 150 to the memory 140. The first control signal provided from the protocol stack processor 120 is a payload message informing of position information of a header to be added or existence of payload data stored in the memory 140.

The MCU interface unit 220 provides a second control signal between the packet data transfer apparatus 130 and the microcontroller 110. The second control signal provided from the microcontroller 110 is a transfer completion message of packet data, which informs storage completion of the packet data in the memory 140. The second control message provided to the microcontroller 110 is a payload message informing that payload data having a header removed therefrom exists in the memory.

The modem interface unit 230 provides a third control signal between the packet data transfer apparatus 130 and the modem 150. The packet data transfer apparatus 130 receives, through the modem interface unit 230, a message informing the delivery of packet data that the modem 150 receives from another mobile communication system through an antenna.

The data pointer calculation unit 240 calculates a data pointer of the memory under the control of the microcontroller 110 and the protocol stack processor 120. The data pointer calculation unit 240 may calculate a position of the packet data to be added by the protocol stack processor 120 from the position information received through the PSP interface unit 210 in the downlink packet data transfer process. Alternatively, the data pointer calculation unit 240 may calculate a position at which the packet data received from the modem is to be stored in the memory 140 in the uplink packet data transfer process.

The data transfer unit 250 transfers data between the memory 140 and the modem 150 based on the position calculated by the data pointer calculation unit 240. The data transfer unit 250 reads, from the memory 140, the packet data transferred from the microcontroller 110 and the header added by the protocol packet processor 120 and transfers the packet data and the header to the modem 150 in the downlink packet data transfer process. Alternatively, the data transfer unit 250 transfers the packet data received from the modem 150 to the position calculated by the data pointer calculation unit 240 in the uplink packet data transfer process. If the transfer of data is completed, the data transfer unit 250 informs, through the PSP interface unit 210, the protocol stack processor 120 that the packet data received through the modem 150 is positioned in the memory 140.

The memory 140 exists separately from the protocol stack processor. In the downlink packet data transfer process, the memory 140 stores information on packet data to be transferred to another mobile communication system through the modem 150, a header added by the protocol stack processor 120, and the like. In the uplink packet data transfer process, the memory 140 stores information on packet data to be transferred to another mobile communication system through the modem 150, a position of payload data identified by the protocol stack processor 120, and the like.

The modem 150 is connected to an antenna so as to perform data communication with another mobile communication system. The modem 150 may receive packet data from another mobile communication system or transfer packet data to another mobile communication system.

The packet data transfer apparatus in the mobile communication system configured as described above can reduce a load of the protocol stack processor 120, caused by the packet data transfer to the protocol stack processor 120 and the packet data transfer from the modem 150, in the process of storing the packet data in the memory, processing the packet data through the uplink or downlink packet data transfer process and then transferring the packet data to the modem 150 so as to process the packet data in the protocol stack processor 120. Accordingly, it is possible to improve the efficiency of the protocol stack processor 120.

Further, the packet data transfer apparatus 130 is positioned between the protocol stack processor 120 and the memory 140 so as to reduce the load of the protocol stack processor 120. Accordingly, it is possible to effectively use performance of the protocol stack processor 120 and implement a modem for mobile communication using low power.

Meanwhile, a packet data transfer method in the mobile communication system, which is divided into downlink packet data transfer and uplink pack data transfer, will be described in detail as follows.

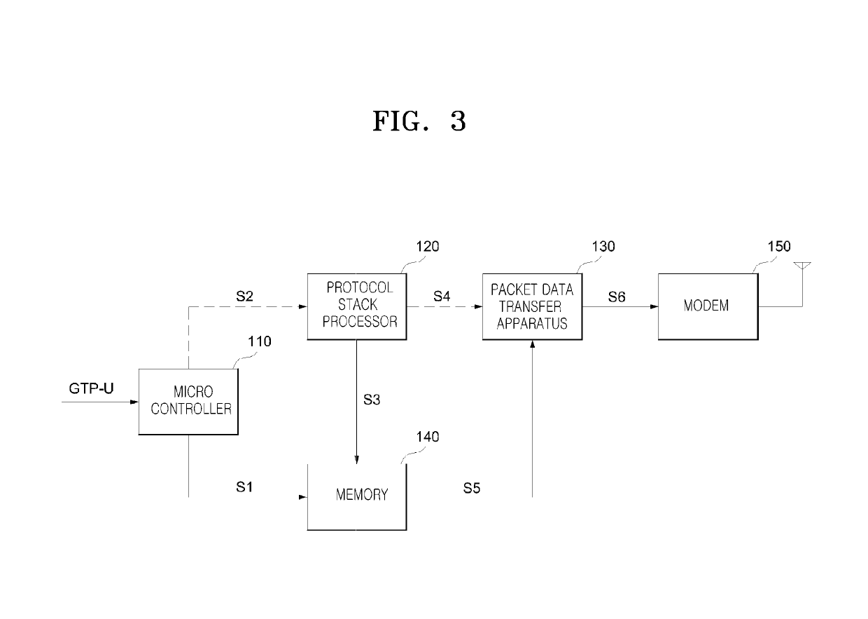

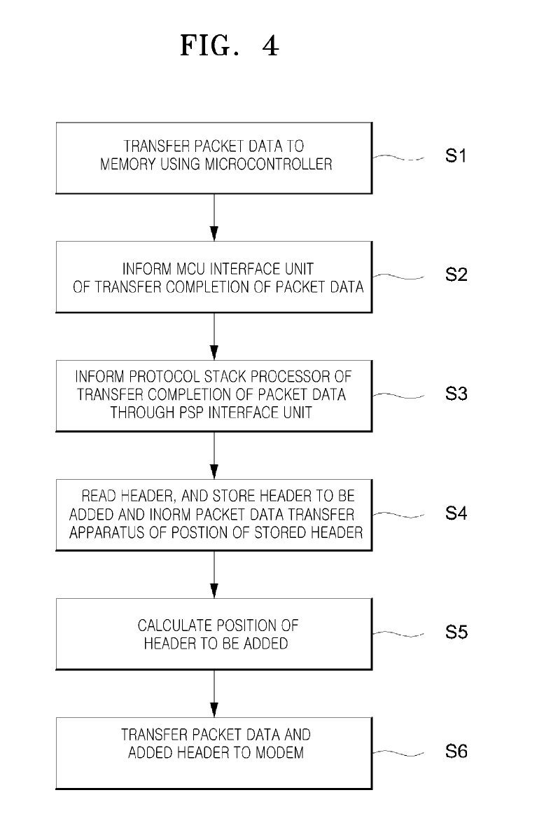

FIG. 3 is a block diagram illustrating the configuration of flows of data and signals for downlink data transfer in the mobile communication system according to an embodiment of the present invention. FIG. 4 is a flowchart illustrating a downlink packet data transfer method according to the embodiment of the present invention.

First, since the microcontroller 110 is connected to an external Ethernet, the microcontroller 110 receives packet data to be transferred to another mobile communication system through the external Ethernet and transfers the received packet data to the memory 140 (S1).

If the process of transferring the packet data to the memory 140 is completed, the microcontroller 110 informs the protocol stack processor 120 that the packet data transfer has been completed by transferring a transfer completion message to the protocol stack processor 120 through the MCU interface unit 220 (S2).

The transfer completion message is provided to the protocol stack processor 120 through the PSP interface unit 210 (S3). That is, the microcontroller 110 informs the protocol stack processor 120 that the packet data has been transferred to the memory 140.

The protocol stack processor 120 reads a header of the packet data from the memory 140 and stores the header to be added in a protocol stack. Then, the protocol stack processor 120 informs the packet data transfer apparatus 130 of position information of the header through the PSP interface unit 210 (S4).

The data pointer calculation unit 240 calculates a position of the header to be added to the memory, which is received from the protocol stack processor 120 through the PSP interface unit 120 (S5).

The data transfer unit 250 reads the packet data transferred from the microcontroller 110 and the header added by the protocol stack processor 120 and transfers the packet data and the header to the modem 150, based on the position calculated by the data pointer calculation unit 240 (S6).

Subsequently, the modem 150 transfers the corresponding data (the packet data and header) to another mobile communication system through an antenna, thereby completing downlink packet data transfer.

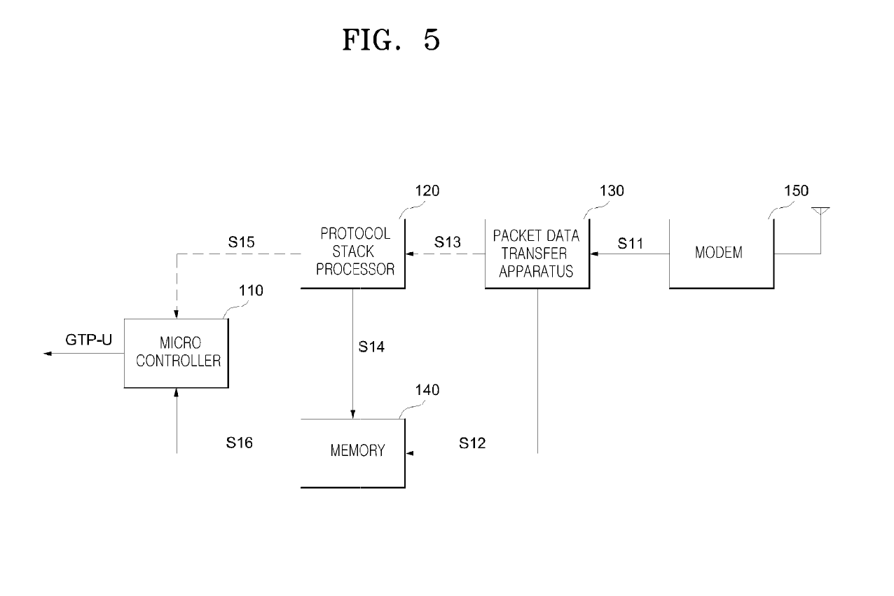

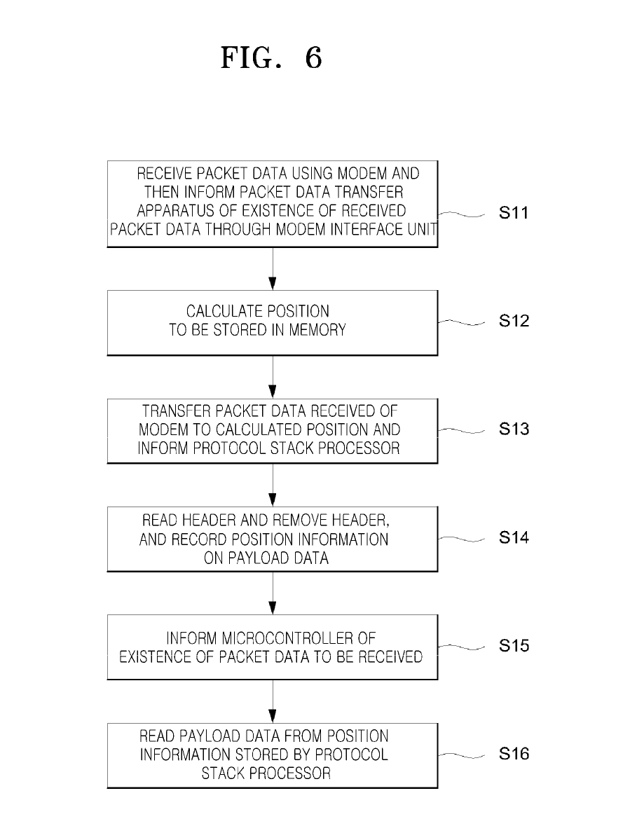

FIG. 5 is a block diagram illustrating the configuration of flows of data and signals for uplink data transfer in the mobile communication system according to another embodiment of the present invention. FIG. 6 is a flowchart illustrating an uplink packet data transfer method according to the embodiment of the present invention.

First, the modem 150 receives packet data from another mobile communication system through an antenna and then informs the packet data transfer apparatus 130 that the packet data was received through the modem interface unit 230 (S11).

The data pointer calculation unit 240 calculates a position at which the packet data received from the modem 150 is to be stored in the memory 140 (S12).

The data transfer unit 250 transfers the packet data received from the modem 150 to the position of the memory, calculated by the data pointer calculation unit 240 and then informs the protocol stack processor 120 that newly received packet data has been positioned in the memory 140 by providing a reception completion message to the protocol stack processor 120 through the PSP interface unit 210 (S13).

If the protocol stack processor 120 receives the reception completion message, the protocol stack processor 120 reads the header from the memory 140 and removes the header from the packet data. Then, the protocol stack processor 120 records position information on payload data at a point previously specified in the memory 140 (S14).

The protocol stack processor 120 informs the microcontroller 110 that there exists packet data to be received through the PSP interface unit 210 and the MCU interface unit 220 (S15).

The microcontroller 110 reads the payload data based on the position information recorded at the point previously specified in the memory (S16), thereby completing uplink packet data transfer.

As described above, in the mobile communication system according to the present invention, the packet data transfer apparatus reduces a load of a protocol stack processor, which causes performance degradation due to a considerable time taken to transfer a large amount of packet data to a memory of a packet processor from Ethernet, so that the clock speed of the processor can be lowered. Accordingly, it is possible to implement a modem for mobile communication using low power.

Further, the packet data transfer apparatus is positioned between a processor and a memory so that the processor does not perform packet data transfer from the outside to an internal memory of the process or packet data transfer from the internal memory of the process to the outside. Accordingly, it is possible to reduce packet data transfer of the processor.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A packet data transfer method in a mobile communication system, the method comprising:
transferring, by a microcontroller, packet data to a memory;
informing, by the microcontroller, a packet data transfer apparatus of transfer completion of the packet data;
informing, by the packet data transfer apparatus, a protocol stack processor that the packet data has been transferred to the memory;
reading, by the protocol stack processor, a header of the packet data from the memory, storing the header to be added to a protocol stack and then informing the packet data transfer apparatus of position information on the header;
calculating, by the packet data transfer apparatus, a position of the header added to the memory; and
reading, by the packet data transfer apparatus, the packet data and the header based on the calculated position and transferring the packet data and the header to a modem.

2. The method of claim 1, wherein the informing of the packet data transfer apparatus of the transfer completion of the packet data is performed through an MCU interface unit of the packet data transfer apparatus for interface with the microcontroller.

3. The method of claim 1, wherein the informing step of the protocol stack processor that the packet data has been transferred to the memory, and the reading of the header of the packet data from the memory, the storing of the header to be added to the protocol stack and the informing of the packet data transfer apparatus of position information on the header step are performed through a PSP interface unit of the packet data transfer apparatus for interface with the protocol stack processor.

4. A packet data transfer method in a mobile communication system, the method comprising:
receiving, by a modem, packet data from another mobile communication system and then informing a packet data transfer apparatus of existence of the received packet data;
calculating, by the packet data transfer apparatus, a position at which the packet data received from the modem is to be stored in a memory;
transferring the packet data of the modem to the calculated position of the memory and then informing the protocol stack processor that newly received packet data has been positioned in the memory;
reading, by the protocol stack processor, a header of the packet data from the memory, removing the header from the packet data and then recording position information of payload data at a point previously specified in the memory;
informing, by the protocol stack processor, a microcontroller of existence of the payload data to receive; and
reading, the microcontroller, the payload data based on the position information recorded at the point previously specified in the memory.

5. The method of claim 4, wherein the receiving of the packet data from another mobile communication system and then the informing of the packet data transfer apparatus of existence of the received packet data are performed through a modem interface unit of the packet data transfer apparatus for interface with the modem.

6. The method of claim 4, wherein the transferring of the packet data of the modem to the calculated position of the memory and the informing of the protocol stack processor that the newly received packet data has been positioned in the memory are performed through a PSP interface unit of the packet data transfer apparatus for interface with the protocol stack processor.

7. The method of claim 4, wherein the reading of the header of the packet data from the memory, the removing of the header from the packet data and the recording of the position information of payload data at the point previously specified in the memory are performed through the PSP interface unit of the packet data transfer apparatus for interface with the protocol stack processor and an MCU interface unit of the packet data transfer apparatus for interface with the microcontroller.

8. A packet data transfer apparatus in a mobile communication system, the apparatus comprising:
a PSP interface unit configured to communicate a first control signal with a protocol stack processor for analyzing a protocol of received packet data;
an MCU interface unit configured to communicate a second control signal with a microcontroller for communicating the packet data through Ethernet;
a modem interface unit configured to communicate a third control signal with a modem for communicating the packet data with another mobile communication system;
a data pointer calculation unit configured to calculate a data pointer of a memory under the control of the microcontroller and the protocol stack processor; and
a data transfer unit configured to transfer both first packet data stored in the memory by the microcontroller and the header added by the protocol stack processor to the modem, or to transfer second packet data received by the modem from the another mobile communication system to the memory, based on the data pointer calculated by the data pointer calculation unit.

9. The apparatus of claim 8, wherein the first control signal is one of a transfer completion message informing of transfer completion of the first packet data from the microcontroller to the memory, a reception completion message informing of reception completion of the second packet data from the modem to the memory, position information of the header to be added by the protocol stack processor and a payload message informing of existence of payload data in the memory, the second control signal is one of the transfer completion message and the payload message, and the third control signal is a message informing of existence of the second packet data.
